(19) United States
(12) Patent Application Publication
(10) Pub. No.: US 2026/0202543 A1
(43) Pub. Date: Jul. 16, 2026

(54) SYSTEM AND METHOD FOR INTERFEROMETRICALLY MEASURING A DISTANCE

(71) Applicant: ATTOCUBE SYSTEMS GMBH, Haar bei München (DE)

(72) Inventors: Timon LUKAS, München (DE); Christian SCHWEMMER, Happurg (DE); Markus KIRBERG, Hiddenhausen (DE)

(73) Assignee: ATTOCUBE SYSTEMS GMBH, Haar bei München (DE)

(21) Appl. No.: 19/135,164

(22) PCT Filed: Dec. 18, 2023
(86) PCT No.: PCT/EP2023/086227

§ 371 Date: Jun. 3, 2025

(30) Foreign Application Priority Data
Dec. 20, 2022 (EP) 10 2022 134 005.8

(51) Int. Cl. G01S 17/36; G01S 7/4915; G01S 7/497

(52) U.S. Cl. CPC G01S 17/36; G01S 7/4915; G01S 7/497

(57) ABSTRACT

System and method for interferometrically measuring distance between reference and target surfaces includes a tunable radiation source for generating a radiation emission with a wavelength dependent on a modulation parameter, and a control-module controls the modulation parameter such that the wavelength of the radiation emission is modulated periodically between first and second reference wavelengths. An interferometer-module generates a first reflection on the reference surface based on a first part of the radiation emission and a second reflection on the target surface based on a second part of the radiation emission, whereby an interference signal is generated by the first reflection and the second reflection. A detector-module captures the interference signal. An evaluation-module provides a phase measurement between the first and second reference wavelengths on the basis of the captured interference signal and determine the distance between the reference surface and the target surface on the basis of the phase measurement.

### BACKGROUND OF THE INVENTION

### 1. Field of Invention

The present invention relates to a system and a method for interferometrically measuring a distance.

### 2. Description of the Related Art

Interferometric methods can be used to measure distances and, with particular ease, to measure changes in distance relative to an initial value. The progressive development of various measurement setups, the miniaturization thereof, and modern capabilities for data processing open up additional fields of application for such techniques, for example for the positioning and monitoring of components or tools.

A device and a method for interferometric measurement are known from DE 102017113997 B4. Interferometry is used to interferometrically measure the rotation of a body around a rotation axis.

EP 3418678 A1 proposes a method and a detector for image formation in correlation with interferometry. An imaging of a surface is also to be carried out in parallel to an interferometric measurement. The method allows for the relative measurement of distances and of changes in distance.

A measuring apparatus comprising an interferometer and an absorption medium defining a dense line spectrum is known from EP 2847538 A1.

EP 2589923 B1 describes a counter-chirped frequency-scan interferometer with multiple laser sources. An interferometric distance measurement is provided, thereby varying the frequencies of multiple light sources.

EP 2149778 B1 describes a method and apparatus for measuring displacement using multi-wavelength interferometry. The method provides for the simultaneous measurement of interference values for a plurality of laser beams of different wavelengths.

EP 3161408 B1 proposes an apparatus and method for dual laser source interferometry in which the frequencies are swept. The method is based on the use of two laser sources simultaneously, with one of the laser sources operating at a variable frequency and the other at a fixed frequency.

EP 2877810 B1 proposes an interferometric distance measuring arrangement in which a measuring beam is split into at least two channels in parallel by means of a beam splitter.

A method and apparatus for interferometric absolute measurement of a distance are known from DE 102015110362 B4. There, interferometry is used to measure an absolute distance. The frequency of a coherent light source is cyclically tuned by mechanically adjusting the length of a reference interferometer, and an absorption line at a known wavelength can be used to keep a particular wavelength constant.

Furthermore, the measurement of a cavity by means of interference spectroscopy is known from DE 102016103109 B4. A coherent light source is tuned over a frequency range. A numerical fit of an interference spectrum is performed to determine a geometric and/or optical parameter of the cavity.

One of the challenges with known methods and systems is to be able to perform distance measurements for moving objects, for example during an active movement of the target object, or to be able to perform reliable measurements despite a drift, particularly when using only a single beam source.

### SUMMARY OF THE DISCLOSURE

It is the object of the present invention to provide a system and a method for interferometrically measuring a distance which is improved compared to the prior art. In particular, it should be possible to reliably measure a changing distance.

The object is achieved according to the invention by a system and a method with the features of the independent claims. Advantageous embodiments are indicated in the dependent claims.

Accordingly, the object is achieved by a system for interferometrically measuring a distance between a reference surface and a target surface, said system comprising a tunable radiation source for generating a coherent radiation emission with a wavelength dependent on a modulation parameter. The system further comprises a control module which is configured to control the modulation parameter such that the wavelength of the generated radiation emission is modulated periodically between a first and a second reference wavelength, and an interferometer module which is configured to generate a first reflection at the reference surface on the basis of a first part of the radiation emission and to generate a second reflection at the target surface on the basis of a second part of the radiation emission, whereby an interference signal is generated by the first reflection and the second reflection. The system also comprises a detector module which is configured to capture the interference signal and an evaluation module which is configured to perform a phase measurement between the first and the second reference wavelength on the basis of the captured interference signal and to determine the distance between the reference surface and the target surface on the basis of the phase measurement.

The invention makes use in particular of the insight that sweeping over a certain wavelength range sufficiently quickly enables the interferometric measurement of absolute distances to be carried out with great precision. The evaluation of the resulting interferometry signal is especially simple and fast if a phase counter measures the phase shift during the tuning of the laser between two defined wavelengths. The high speed of the individual measurements also allows for a statistical evaluation of a large number of measured values and thus ensures a high level of measurement accuracy even when the distance between the reference surface and the target surface changes relatively quickly.

An inherently known tunable radiation source, in particular a laser, can be used. Different modulation parameters can be used individually or in combination for tuning—that is, for variably adjusting the wavelength of the radiation emission. For example, the wavelength can be dependent on a current applied to the radiation source. Furthermore, the wavelength can be dependent on the temperature of the radiation source. Furthermore, the wavelength can be adjustable through adjustment of a cavity of the radiation source, for example of an internal or external cavity.

The invention makes a provision, in particular, that the wavelength of the light emission of a tunable laser source can be adjusted using an applied current.

A provision can be made that the control module controls the current for tuning the laser source in such a way that a linear change in frequency occurs. This change in frequency is generally not linearly dependent on the current. In particular, the higher the current, the faster the frequency changes. Through suitable control, a constant rate of change of the frequency of the radiation emission (i.e., a constant df/dt) or a constant rate of change of the wavelength of the radiation emission (i.e., a constant dλ/dt) can be achieved.

For example, an infrared laser can be used. Lasers with other wavelengths can be used in an analogous manner.

In particular, the wavelength is modulated in such a way that the first and second reference wavelengths are periodically reached or exceeded.

In one embodiment, the interferometer module is embodied as a Fabry-Pérot interferometer, the reference surface being formed in particular by an end face of an optical waveguide. This advantageously allows for an especially simple and extremely compact design of the interferometer. Furthermore, the end of the optical waveguide on a measuring head of the system is advantageously used directly as a reference surface, and no separate device, such as a beam splitter for a reference arm of the light emission, is necessary. Instead, the first part of the radiation emission is reflected at the end of the optical waveguide.

The second part of the radiation emission, however, is decoupled, for example from a measuring head, and directed onto the target surface. Additional optical devices can be provided in order to adjust the direction of the beam or to shape it.

In another embodiment, the interferometer module can be embodied as a Michelson interferometer, in which case a beam splitter is provided which directs the first part of the radiation emission onto a reference surface formed separately from the optical waveguide, whereas the second part of the radiation emission is directed onto the target surface.

Reflections occur of the parts of the radiation emission that strike the reference surface or the target surface. The reflected light is superposed in a known manner, for example through coupling into a common optical waveguide and impingement on a detector, where interference occurs.

For interferometry, a measuring cavity is required which, in the invention, can be provided in the form of a Fabry-Pérot interferometer, for example. This results in a reference reflection at the end of the optical waveguide, where the radiation emission is decoupled and directed onto the target surface. At the interface between the end of the optical waveguide and the surrounding medium (such as air, gas, or vacuum), the refractive index changes abruptly and partial reflection of incident light occurs. Furthermore, the light reflected from the target surface during the second reflection is coupled into the optical waveguide at this interface.

In the present case, the cavity of the Fabry-Pérot interferometer formed between the reference surface and the target surface can be designed with low finesse. For example, in the reference reflection, about 4% of the incident light is reflected at the reference surface (i.e., at the end of the optical waveguide), while the remaining light is transmitted. A provision can be made that the second reflection reflected from the target surface has a similar intensity in order to obtain an advantageous signal-to-noise ratio. If the second reflection occurs on a highly reflective target surface, a spatial filter can be used to attenuate the intensity of the second reflection, for example. Due to its low finesse, the Fabry-Pérot interferometer used allows for measurements with less reflective target surfaces, such as a glass surface.

In selecting a suitable design of the Fabry-Pérot interferometer, it must be taken into account that, for an optimal interference signal, the intensity of the first reflection at the reference surface should be similar to the intensity of the second reflection at the target surface. If the target surface is highly reflective, an attenuator can be used to reduce the intensity. In the extreme case of destructive interference, the signal is canceled out, whereas in the extreme case of positive interference, the signal is doubled.

The detector module can be designed with a photodiode in an inherently known manner. To capture the interference signal, for example, the intensity of the light from the combination of the first and second reflection is detected. Destructive interference results in lower intensity, while constructive interference results in higher intensity.

The progression of the intensity measured in this way is evaluated by the evaluation module together with the information on the wavelength of the radiation emission, in particular when the first and/or second reference wavelength is reached.

In particular, the change in the interferometric phase that occurs when sweeping the range of wavelengths between the first and the second reference wavelength is determined.

In one refinement, the system further comprises a reference module for detecting the wavelength of the radiation emission. The reference module is configured in particular to detect the reaching of the first and second reference wavelength of the generated radiation emission on the basis of another part of the generated radiation emission.

In one embodiment, the reference module is configured to detect the reaching of the first and/or second reference wavelength on the basis of an absorption measurement for a reference gas cell.

In particular, a reference gas cell is used in whose absorption spectrum especially clearly defined characteristic absorption lines occur, for example lines of the rotational-vibrational spectrum. The radiation used for the measurement passes through the reference gas cell, and the transmitted intensity is detected. As the wavelength of the radiation emission changes, the proportion of absorbed radiation also changes, which is detected as a change in the intensity of the transmitted radiation. When the center of an absorption line is reached, the transmitted intensity is minimal, so that even if the wavelength setting or variation is not precisely defined, it is recognized that a known wavelength has been reached. For example, a cyanide, acetylene, or carbon monoxide gas cell can be used.

Furthermore, alternatively or in addition, other methods are conceivable in which in particular atomic transitions are used to detect the reaching of a reference wavelength, in particular also using a frequency comb.

In another embodiment, the control module is configured to control the modulation parameter such that a frequency range of at least 50 GHz, preferably at least 100 GHz, more preferably at least 200 GHz, is covered for the generated radiation emission between the first and the second reference wavelength.

Expressed as a wavelength, a provision can be made that a range of about 1 nm is covered. The wavelength range must be selected so as to be large enough to achieve the required accuracy in the distance determination. On the other hand, it should not be selected too large, since with a constant scanning frequency the speed at which maxima and minima of the interference occur also increases and hence also the required data acquisition speed.

In one refinement, the control module is configured to control the modulation parameter such that a frequency range between the first and the second reference wavelength is covered for the generated radiation emission with a scanning frequency of at least 10 Hz, preferably at least 100 Hz, more preferably at least 1 kHz, more preferably at least 10 kHz, more preferably at least 20 kHz, more preferably at least 50 kHz. The measurement is therefore advantageously carried out quickly enough to compensate for typical drift velocities of the target surface but not too fast with regard to the technical limitations of the detection and processing of the interference signal.

The scanning frequency refers in particular to the number of periods per unit of time within which the frequency range between the first and the second reference frequency is covered.

In another embodiment, a provision can be made that a travel velocity of the target—i.e., a velocity of the target surface—is detected and the scanning frequency is determined as a function of the travel velocity. In particular, a first estimate of the travel velocity is determined, for example, by detecting a user input. Optionally, a more precise value of the actual travel velocity can be determined in a further step.

In one refinement, the control module is configured to control the modulation parameter such that the change in wavelength comprises an additional signal, for example a sawtooth or sawtooth-shaped modulation in the MHz range, the evaluation module being configured in particular to detect a direction of a change in distance on the basis of the additional signal and the captured interference signal. In particular, the amplitude of the modulation is selected such that the signal-to-noise ratio of the measured interferometric phase is as favorable as possible, independent of the interferometric phase.

This means that phase measurement or phase counting can be used to determine the direction of a movement or the change in distance (drift) between the reference surface and the target surface.

For example, a bias current of the radiation source is modulated, for instance with sawtooth or sinusoidal modulation. For example, the frequency of the modulated signal can be in the MHz range if the scanning frequency is in the kHz range; in general, the frequency of the modulated signal can be about three orders of magnitude higher than the frequency of the sweep or the scanning frequency.

In one embodiment, the control module is configured to control the modulation parameter such that the radiation emission has the first or second reference wavelength after the distance between the reference surface and the target surface has been determined. The evaluation module is configured to detect a change in distance between the reference surface and the target surface on the basis of the interference signal.

The change in distance can be detected as a function of time, meaning that a rate of the change in the distance between the reference surface and the target surface is determined. Such a change can occur due to a drift, for example due to a temperature-dependent expansion or contraction of a material and a resulting change in distance. Furthermore, the change in distance can be actively produced by moving the target surface relative to the reference surface, for example when moving a tool.

In such a design, the system is particularly configured to first carry out an absolute measurement of the distance by scanning the frequency range between the first and the second reference wavelength with a scanning frequency. The interference signal is captured, and the distance is determined using a phase measurement.

For this distance determination, it is particularly the change in the interferometric phase of the interference signal that is measured when sweeping over a known wavelength interval. The wavelength interval results from the difference between the first and the second reference wavelength between which the change in the interferometric phase is detected.

The periodic crossing of the frequency range takes place in particular until the confidence of the determined distance lies within a predetermined value. In the case of a static distance between the reference surface and the target surface, it is assumed that the more measurements are taken, the more accurate the average value will be. This means that the distance values determined each time the frequency range is swept are evaluated using statistical methods, and the number of individual measurements taken into account (i.e., the values determined each time the frequency range is swept) is selected so as to be large enough to achieve a predetermined level of statistical accuracy in the measurement.

The invention makes use of the possibility of carrying out the individual measurements—in particular the scans over a well-defined wavelength range—at a high frequency. Even with some drift, a sufficient number of measurements can be performed to obtain a good confidence level. This means that a large number of individual measurements can be averaged, with the maximum usable number of measurements or the required scanning frequency depending on the drift velocity. It is also possible to determine the drift velocity in this way. In contrast, in known methods which require a longer time to cover the wavelength range, even a relatively low drift velocity can make an accurate measurement or the repeated repetition of the measurement impossible or at least difficult.

If the absolute distance is not constant, the accuracy may be affected by the relative movement between the reference surface and the target surface. The distribution of the measured individual values can be evaluated directly or implicitly, for example using a Kalman filter. The velocity and/or acceleration between the reference surface and the target surface can also be determined. Alternatively or in addition, machine learning or artificial intelligence techniques can be used to determine the velocity and/or acceleration of a drift.

In other examples, the phase can be determined when an absorption line is reached. If this value changes over time, then the velocity and acceleration can be determined from it.

It is also possible to use a second interferometer to measure the movement directly and, if necessary, to take it into account when determining the absolute distance. Alternatively or in addition, a time-of-flight measurement can be used to directly measure the velocity and/or acceleration.

In a further step, the system can now be configured to control the radiation source in such a way that the generated light emission constantly has a known wavelength. If there is a change in the interferometric phase, this is indicative of a change in the distance between the reference surface and the target surface. With a known wavelength, the change in distance can now be determined.

By modulating an additional signal as described above, the direction of the change in distance can be determined.

Together with the previously detected absolute distance, an updated absolute distance can be determined on the basis of the now determined relative distance.

In other cases, the change in the interferometric phase may be caused by a change in the optical properties of the measuring cavity between the reference surface and the target surface. Such a parameter, such as the optical density of the optical medium traversed, can also be determined from the interference signal.

In another embodiment, the system comprises a device for splitting the radiation emission into two or three sub-beams, by means of which separate interferometer modules are supplied with an output radiation. In each of the interferometer modules, a first part of the sub-beam is reflected from a reference surface and a second part of the sub-beam is reflected from a target surface, whereby the first and second reflections generate an interference signal. This interference signal can be captured and evaluated for each of the interferometer modules. This enables the system to measure two or three distances, for example to measure a two-or three-dimensional position of an object.

In one refinement, the system also has a calibration mode. The calibration mode can be activated, for example, on the control module and/or another module. The evaluation module, optionally a separate calibration module or another module, is configured to detect a rate of maxima of the interference signal in calibration mode. The maxima of the interference signal occur when the wavelength of the radiation emission is modulated periodically.

The rate of maxima can be determined, for example, based on the number of maxima detected per time interval or on the time intervals between detected consecutive maxima. In particular, it can be determined whether the maxima are being detected at a constant rate.

In particular, a constant distance between the reference surface and the target surface is assumed. This is achieved in particular by using a reference cavity having a substantially temperature-independent length, for example using a material such as Zerodur®, stainless steel, or Invar®, so that any drift during the measurement period is small or not measurable.

The distance during the measurement does not have to be known exactly, it being sufficient for it to be constant or for any drift during the measurement to be quantitatively known and compensated for during the evaluation. In particular, no distance between the reference surface and the target surface is determined in calibration mode; instead, this distance is regarded as known for the duration of the measurement.

Furthermore, a drift of a reference cavity can be determined using a second laser interferometer. A drift measurement using a single radiation source is also possible, although a lower rate is then accepted.

A provision can also be made that the control module or the control of the modulation parameter can be calibrated on the basis of the detected rate in such a way that a constant rate of maxima is obtained when modulating the wavelength. In particular, the modulation of the wavelength of the radiation emission takes place with a constant rate of change of the frequency of the radiation emission df/dt or with a constant rate of change of the wavelength of the radiation emission, i.e., with a constant dλ/dt. During tuning of the radiation source, the maxima are then detected at a constant rate.

In other words, the rate of maxima during the measurement or during the periodic tuning of the radiation source through calibration can be used to ensure that the modulation of the wavelength occurs with a constant rate of change of the frequency of the radiation emission, i.e., with a constant df/dt, or with a constant rate of change of the wavelength of the radiation emission, i.e., with a constant dλ/dt.

In one refinement of the system, a reference cavity can be connected for operation in calibration mode. In particular, the reference cavity is embodied such that it comprises a temperature-independent material and that no or no significant drift of the measured distance occurs.

The reference cavity can have a length that is substantially temperature-independent, where “substantially” means that no measurable drift or, for example, a drift of less than 10 nm per second occurs within the measurement period.

The reference cavity can be connected, for example, by connecting it to a measuring head of the system, with the reference cavity defining a length between the reference surface and a reference target surface of the reference cavity.

For example, the cavity can be connected in a location in which the radiation emission is decoupled outside the calibration mode and directed onto the target surface or onto a target.

Furthermore, the interferometer module can be embodied such that the first and second reflections are obtained at the reference cavity, for example using an optical switch.

In particular, a provision can be made that the system comprises an integrated reference cavity, in which case the optical switch can be used to switch between a first configuration in which the light emission is decoupled toward the target surface and a second configuration in which the light emission is decoupled toward the reference cavity. For example, two “arms” of optical waveguides can be provided for the first and second configurations.

In other words, a calibration mode can be provided for the system in which it is not the distance to the target that is measured, but rather a fixed distance of an external, optionally even internally installed cavity with a substantially temperature-independent length. A material that is stable against temperature changes such as Zerodur®, stainless steel, or Invar® can be used for this purpose. In particular, it should be ensured that the radiation source or the laser used is modulated in such a way that a constant frequency change df/dt is obtained during “chirping”, i.e., during periodic modulation of the frequency. If the maxima are detected at a constant rate during chirping with the cavity, then the frequency change df/dt is constant.

An external cavity can be connected to the system where the target would otherwise be located, or an optical switch can be built into the system to create another “arm” and switch the light path to the reference cavity.

In one refinement, the system further comprises a second radiation source for generating a second coherent radiation emission with another wavelength.

The additional wavelength can, for example, be in the so-called telecom range, i.e., in an infrared range of the electromagnetic spectrum.

A reference gas cell can be used, such as acetylene, cyanide, and/or carbon monoxide. Furthermore, a gas cell containing two gases can be used, or two lines of the same cell can also be used. Furthermore, two reference gas cells can be provided in order to also ensure the correct additional wavelength of the second radiation emission.

In this case, an optical switching unit or an optical switch is provided which can be switched between a first switching state in which the first radiation emission is coupled into the interferometer module and a second switching state in which the second radiation emission is coupled into the interferometer module.

The optical switching unit is preferably embodied such that switching can be carried out within a maximum of 5 ms, preferably in a range between 50 μs and 5 ms.

In particular, an optical switching unit with the fastest possible switching time is used.

The optical switching unit or the optical switch can, for example, be embodied such that the “switched off” radiation emission is suppressed by at least 50 dB, preferably by at least 60 dB.

In another embodiment, the system is configured to successively carry out the following in order to measure the distance:
a. to generate a first interference signal by means of the first radiation emission and determine a first distance value;
b. to generate a second interference signal by means of the second radiation emission and to determine a second distance value; and
c. to determine the distance on the basis of the first and second distance values.

For example, when determining the first distance value (a), a drift velocity, in particular a temporal change in the distance to be measured, can be determined or estimated. The drift velocity can then be taken into account when determining the distance on the basis of the first and second distance values (c).

The system can be configured to determine the first distance value (a) such that a confidence determined for the first distance value falls below a predetermined threshold value. For example, the maximum tolerable error after the second measurement can be half of the wavelength used.

For example, the confidence can be adjustable, for example between 3 sigma up to 6 sigma. In particular, the system is configured to determine, based on the set confidence, how many individual measurements are necessary in order to achieve the required accuracy.

The second distance value (b) can then be determined.

In order to determine the first distance value with the required confidence, the measurement duration is adjusted, meaning that the number of individual measurements and “sweeps” carried out—i.e., the number of periodic tunings of the radiation source—is adjusted.

In other words, in order to improve the accuracy with a shorter measurement time, a few measurements can first be carried out with the first radiation source, for example 50 to 100 measurements, in order to obtain a first distance value for the absolute distance with a certain statistical accuracy of, for example, 5 to 10 μm. The system then switches to the second radiation source in a different wavelength range and measures the phase. This then results in additional distance information, particularly relative distance information by means of which the accuracy of the first distance value can be improved, for example in order to achieve a level of accuracy in the nm range.

In known systems, similar measurements are only performed with a simultaneous measurement at two wavelengths. The sequential measurement described here is not possible there because the distance between the reference surface and the target surface or target can change between the first and the second measurement, in particular due to temperature-related drift.

In the solution described herein, a drift velocity can be estimated on the basis of the data from the first measurement, for example about 500 μm/s, in order to be able to estimate and compensate for the drift during switching using an optical switch.

This approach makes a faster and simultaneously highly accurate measurement possible, whereas otherwise a very long measurement with the first wavelength is necessary in order to obtain the high statistical accuracy.

In the method for interferometrically measuring a distance between a reference surface and a target surface, a coherent radiation emission with a wavelength that is dependent on a modulation parameter is generated by means of a tunable radiation source. The modulation parameter is controlled such that the wavelength of the generated radiation emission is modulated periodically between a first and a second reference wavelength. A first reflection is generated at the reference surface on the basis of a first part of the radiation emission, and a second reflection is generated at the target surface on the basis of a second part of the radiation emission, so that an interference signal is generated by the first reflection and the second reflection. The interference signal is captured, a phase measurement is performed between the first and second reference wavelengths on the basis of the captured interference signal, and the distance between the reference surface and the target surface is determined on the basis of the phase measurement.

The method is used in particular to operate the system and therefore has the same advantages as the system. Furthermore, the method can in principle be refined in the same manner as the system.

### BRIEF DESCRIPTION OF THE DRAWINGS

Further details and advantages of the invention will now be explained in greater detail with reference to an exemplary embodiment that is illustrated in the drawings, in which:

FIG. 1 is a schematic representation of an exemplary embodiment of the system;

FIG. 2 is a diagram showing central values that are set or measured during an exemplary operation of the system;

FIG. 3 is a flowchart of an exemplary embodiment of the method; and

FIG. 4 is a schematic representation of another exemplary embodiment of the system.

### DETAILED DESCRIPTION THE INVENTION

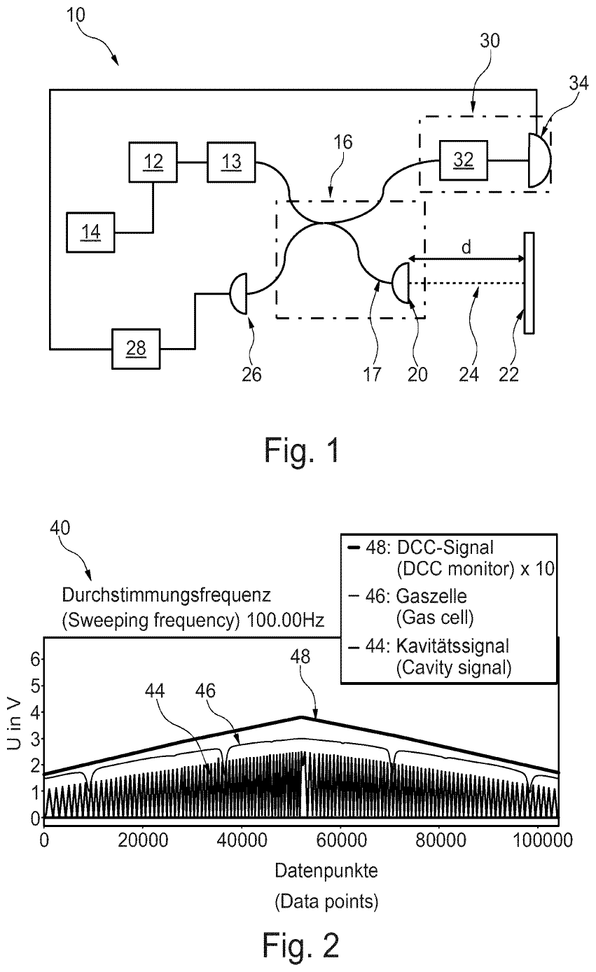

A schematic representation of an exemplary embodiment of the system will be explained with reference to FIG. 1.

In the exemplary embodiment, the system 10 comprises a tunable radiation source 12.

In the present exemplary embodiment, this is embodied as a laser source 12.

The laser source 12 is coupled to a control module 14. The control module 14 outputs a bias current that determines the wavelength of a radiation emission generated by the laser source 12. The bias current therefore serves as a modulation parameter in the present exemplary embodiment.

In further exemplary embodiments, other modulation parameters may be used, such as a temperature or a length of a resonator cavity of the laser source 12.

The radiation emission generated by the laser source 12 is coupled into a optical waveguide and reaches an isolator 13, which prevents light from returning to the laser source 12.

An interferometer module 16 is optically coupled to the isolator 13 via an optical waveguide. This comprises at least one optical waveguide 17 at the end of which a measuring head 20 is located. There, light is decoupled as a light beam 24 at one end face of the optical waveguide 17.

In the exemplary embodiment, a portion of the radiation emission generated is directed to a reference module 30 and passes there through a reference gas cell 32. The light transmitted there is detected by a reference detector 34, with in particular the intensity of the transmitted radiation being detected in particular.

In the exemplary embodiment, a cyanide gas cell is used as reference gas cell 32. In further exemplary embodiments, other gaseous materials—such as acetylene or carbon monoxide, for example—or other methods may be used.

The reference module 30 or the reference detector 34 is coupled to the evaluation module 28, where the detected values for the intensity of the transmitted light are processed.

The sudden change in the refractive index at the interface between the optical waveguide 17 and the surrounding medium (such as gas, air, or vacuum) results in a first reflection of a first part of the light. This surface is therefore a reference surface 20 in the exemplary embodiment.

This means that the first part of the light is reflected back in the optical waveguide 17, while a second part is decoupled.

The measuring head 20 is embodied such that the second part of the radiation emission, decoupled as a light beam 24, strikes a target surface 22 and is reflected there. This second reflection is thrown back to the measuring head 20 and coupled into the optical waveguide 17.

In the detector module 26, interference occurs between the light of the first reflection and the light of the second reflection, and an interference signal is measured.

The system 10 according to the exemplary embodiment therefore comprises a Fabry-Pérot interferometer. In other exemplary embodiments, other interferometers may be used, in particular a Michelson interferometer.

The interferometer module 16 is embodied such that the resulting interference signal is captured by the detector module 26.

The detector module 26 is designed in an inherently known manner. In particular, it comprises a photodiode.

The intensity of the incident interference signal is detected by means of the detector module 26.

The evaluation module 28 coupled to the detector module 26 evaluates the captured interference signal and determines the distance d between the reference surface 20 and the target surface 22 on the basis of a phase measurement upon passing through a certain wavelength interval.

In the exemplary embodiment, the intensity of the light transmitted through the reference gas cell 32 measured by the reference detector 34 is used to determine when the light emission is maximally absorbed by the reference gas cell 32. This is determined on the basis of minima of intensity. Since the absorption maxima of the reference gas cell 32 occur at clearly defined wavelengths, the wavelength of the radiation emission is able to be precisely defined at this point. When two absorption maxima are scanned, it can therefore be detected when the radiation emission has the corresponding wavelengths. The evaluation module 28 can therefore determine the phase of the signal when sweeping over a precisely defined wavelength interval.

In a another exemplary embodiment, a provision is made that a reference cavity is connected to the system 10. This can be done in such a way that the target surface 22 is provided by the reference cavity and that the distance d to the reference surface 20 is constituted by an element made of a substantially temperature-independent material. The distance d is then constant, or any drift can be neglected over the period of a measurement.

In a variant of this further exemplary embodiment, a reference cavity can be integrated into the system 10. An optical switching element can be provided in such a way that the light emission either reaches the reference surface 20 and is decoupled to the target surface 22 or it can reach another reference surface and the reference cavity via another “arm” of the optics.

In the further exemplary embodiment, a calibration mode can be provided. When the calibration mode is activated, it is assumed that measurements are taken at a fixed distance d. Optionally, an optical switch can be controlled such that measurements are taken via an integrated reference cavity.

For calibration measurements, the wavelength of the radiation source 12 is modulated periodically as already explained above (so-called “chirping”).

It is now checked at what rate the maxima of the interference signal are detected and whether the rate is changing or whether it is constant. If the rate is constant, then this means that the chirping is carried out with a constant rate of change of the frequency of the radiation emission df/dt or at a constant rate of change of the wavelength of the radiation emission dλ/dt. If this is not the case, the calibration can be carried out in such a way that this condition is fulfilled.

A diagram with central values that are set or measured during an exemplary operation of the system will now be explained with reference to FIG. 2. The above-described exemplary embodiment of the system 10 will be used as the basis.

The diagram 40 shows a curve of a modulation parameter 48—in this case a bias current 48—which is applied to the radiation source 12 by means of the control module 14.

In this example, the progression of the bias current 48 with linear sections is shown as a triangular waveform.

In further exemplary embodiments, the bias current 48 can be adjusted non-linearly in such a way that the resulting change in the wavelength of the radiation emission is linear.

In the exemplary embodiment, a provision is also made to superpose an additional signal on the modulation of the bias current 48. This then allows for an improved evaluation of the resulting signal, particularly in order to determine the direction of a change in distance between the reference surface 20 and the target surface 22.

A curve of the measured interference signal 44 is also shown. This is substantially sinusoidal.

In addition, a curve 46 of the signal detected by the reference detector 34 is shown. Local minima are visible, which indicate the position of the respective absorption maxima of the reference gas cell 32. In the exemplary embodiment, a fit of the acquired curve 46 is carried out such that the position of the absorption maxima is determined with the greatest possible accuracy; in particular, the fit is carried out in real time.

The phase of the interference signal 44 between the absorption maxima of the reference gas cell 32—i.e., when sweeping over the wavelength interval defined on that basis—can be determined by means of a phase counter.

The phase can now be used to determine the absolute distance between the reference surface 20 and the target surface 22.

The allocation of the absorption maxima to the corresponding bias current 48 also enables the laser source 12 to be adjusted to a precisely known wavelength.

When operating with a constant, known wavelength of radiation emission, the interference signal can continue to be captured. If a change in phase occurs, this can be attributed to a movement between the reference surface 20 and the target surface 22. Such relative movements can therefore be detected during this operation.

As mentioned above, an additional signal can be modulated onto the change in the bias current 48. The frequency of such a signal—which has a sawtooth shape, for example—can be about three orders of magnitude higher than the frequency of the variation of the wavelength between the first and the second reference wavelength.

This additional modulation is particularly advantageous in this operation with a fixed wavelength in order to be enable the direction of a change in distance to be determined as a function of the time derivative of the interference signal.

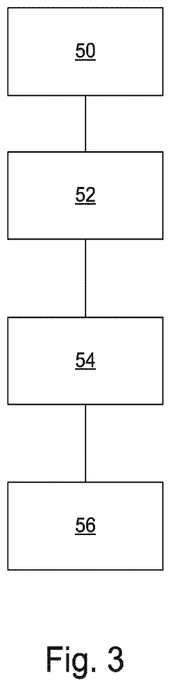

A flowchart of an exemplary embodiment of the method will now be explained with reference to FIG. 3. Here, too, the exemplary embodiment example of FIG. 1 explained above and the exemplary embodiment of the measurements in FIG. 2 will be used as the basis.

In a first step 50, a radiation emission is generated by means of the radiation source 12. The wavelength of the radiation emission is dependent on the bias current 48 as a modulation parameter, which is provided by the control module 14.

In another step 52, the bias current 48 is periodically controlled such that the wavelength of the radiation emission periodically covers a predetermined wavelength interval. The absorption of a reference gas cell 32 is measured and, based on the defined absorption maxima, it can be recognized when the radiation emission has the corresponding reference wavelengths.

A first part of the radiation emission produces a first reflection at the reference surface 20 and a second part of the radiation emission produces a second reflection at the target surface 22. The reflected rays are superposed at the detector 26, so that an interference signal is generated, which is captured.

In another step 54, the acquired data on the absorption of the light emission and the interference signal are evaluated. The phase change of the interference signal between the first and second reference wavelength is measured. The distance d between the reference surface 20 and the target surface 22 is then determined on the basis of this phase change.

By repeatedly measuring a value for the distance d, a confidence can be determined using statistical methods. In the exemplary embodiment, the measurement is repeated until a certain confidence level is reached.

In another step 56, the laser source 12 is controlled by the control module 14 such that the radiation emission has a defined wavelength. For this purpose, the bias current is adjusted such that a defined absorption maximum is reached at the reference module 30. This means that the wavelength of the radiation emission is known.

By operating at a constant wavelength, the interference signal is now used to check whether further phase changes occur. A relative movement between the reference surface 20 and the target surface 22 can then be determined on the basis of the phase change.

In the exemplary embodiment, a provision is made in particular that the operation with periodic scanning over the wavelength range is carried out alternately with the operation at a fixed wavelength in order to first determine the absolute distance d and then to detect a relative change in distance.

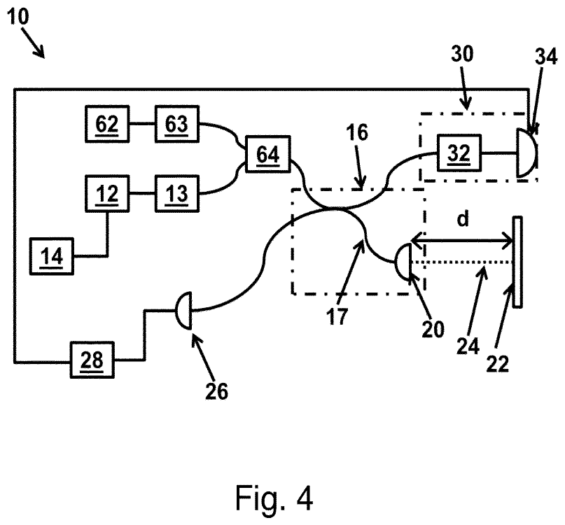

A schematic representation of another exemplary embodiment of the system will now be explained with reference to FIG. 4. The system described above with reference to FIG. 1 will be used as the basis, and only differences will be explained in detail.

Instead of a single radiation source 12, a second radiation source 62 is also provided in the further exemplary embodiment—in this case a laser source 62. This is coupled into the system via an isolator 63.

The second radiation source 62 can also be connected to the control module 14 and controlled by the same.

An optical switch 64 or an optical switch 64 is provided which, on the one hand, has two inputs that are connected to the first 12 and second radiation source 62 and, on the other hand, has an output that is optically connected to the interferometer module 16.

Through actuation of the optical switch 64, either the first 12 or second radiation source 62 can be connected to the output, so that the interferometric measurement is carried out with the light emission of either the first 12 or the second radiation source 62.

In a method for operating the second exemplary embodiment, an interferometric distance measurement is first carried out using the light emission of the first radiation source 12. This is done as explained above. The measurement is carried out long enough—i.e., sufficient individual passes in which the wavelength of the first radiation source 12 is modulated between the first and the second reference wavelength are performed—that a certain predetermined confidence is obtained for the resulting first distance value.

During this first measurement, the drift velocity of the target surface 22 relative to the reference surface 20 is also determined or estimated.

The optical switch 64 is then controlled such that a switch is made to the second radiation source 62 and the measurement is continued therewith. In particular, a phase measurement is now carried out, and a second distance value is determined.

In order to compensate for the drift between reference surface 20 and target surface 22, the drift during switching between the first 12 and second radiation source 62 is determined and taken into account based on the determined drift velocity.

The distance d is then determined on the basis of the first and second distance values.

### List of Reference Symbols

10 system
12 radiation source; laser source
13 isolator
14 control module
16 interferometer module
17 optical waveguide
20 reference surface; measuring head
22 target surface
24 light beam
26 detector module
28 evaluation module
30 reference module
32 reference gas cell
34 reference detector
40 diagram
44 interference signal
46 absorption
48 modulation parameter; bias current
50 step
52 step
54 step
56 step
62 second radiation source; second laser source
63 insulator
64 optical switch; switch
d distance

1. A system (10) for interferometrically measuring a distance between a reference surface (20) and a target surface (22), comprising:
a tunable radiation source (12) for generating a coherent radiation emission having a wavelength dependent on a modulation parameter;
a control module (14) which is configured to control the modulation parameter such that the wavelength of the generated radiation emission is modulated periodically between a first and a second reference wavelength;
an interferometer module (16) which is configured to generate a first reflection at the reference surface (20) on a basis of a first part of the radiation emission and to generate a second reflection at the target surface (22) on a basis of a second part of the radiation emission, so that an interference signal is generated by the first reflection and the second reflection;
a detector module (26) which is configured to capture the interference signal; and
an evaluation module (28) which is configured to perform a phase measurement between the first and the second reference wavelength on the basis of the captured interference signal and to determine the distance between the reference surface (20) and the target surface (22) on the basis of the phase measurement.

2. The system (10) according to claim 1, wherein the interferometer module (16) is embodied as a Fabry-Pérot interferometer, in which case the reference surface (20) is formed in particular by an end face of an optical waveguide (17), or as a Michelson interferometer.

3. The system (10) according to claim 1, further comprising a reference module (30) for detecting the wavelength of the radiation emission, and wherein the reference module (30) is configured in particular to detect the reaching of the first and second reference wavelength of the generated radiation emission on the basis of another part of the generated radiation emission.

4. The system (10) according to claim 3, wherein the reference module (30) is configured to detect the reaching of the first and/or second reference wavelength on the basis of an absorption measurement for a reference gas cell (32).

5. The system (10) according to claim 1, wherein the control module (14) is configured to control the modulation parameter such that a frequency range of at least 50 GHz, preferably at least 100 GHz, more preferably at least 200 GHz, is covered for the generated radiation emission between the first and the second reference wavelength.

6. The system (10) according to claim 1, wherein the control module (14) is configured to control the modulation parameter such that, for the radiation emission generated, a frequency range between the first and the second reference wavelength is covered with a scanning frequency of at least 10 Hz, preferably at least 100 Hz, more preferably at least 1 kHz, more preferably at least 10 kHz, more preferably at least 20 kHz, more preferably at least 50 kHz.

7. The system (10) according to claim 1, wherein the control module (14) is configured to control the modulation parameter such that a change in wavelength comprises an additional signal, for example a sawtooth-shaped modulation in a MHz range, wherein, and the evaluation module is configured to detect a direction of a change in distance on the basis of the additional signal and the captured interference signal.

8. The system (10) according to claim 1, wherein the control module (14) is configured to control the modulation parameter such that the radiation emission has the first or second reference wavelength after the distance between the reference surface (20) and the target surface (22) has been determined, and wherein the evaluation module (28) is configured to detect a change in distance between the reference surface (20) and the target surface (22) on the basis of the interference signal.

9. The system (10) according to claim 1, wherein the system further comprises a calibration mode, wherein the evaluation module (28) is configured to detect a rate of maxima of the interference signal in the calibration mode, wherein the maxima of the interference signal occur when the wavelength of the radiation emission is modulated periodically,
wherein a constant distance between the reference surface (20) and the target surface (22) is preferably assumed,
wherein it is preferably detected whether the maxima are being detected at a constant rate,
wherein the control module (14) is preferably calibrated such that a constant rate of maxima is obtained, the modulation of the wavelength of the radiation emission taking place in particular with a constant rate of change of the frequency of the radiation emission df/dt.

10. The system (10) according to claim 9, wherein a reference cavity can be connected for operation in calibration mode,
wherein the reference cavity preferably has a substantially temperature-independent length,
wherein the connection of the reference cavity is preferably carried out by connecting it to a measuring head of the system (10), the reference cavity defining a length between the reference surface (20) and a reference target surface of the reference cavity, and wherein the interferometer module (16) is preferably embodied such that the first and second reflections are obtained at the reference cavity.

11. The system (10) according to claim 1, wherein the system further comprises a second radiation source (62) for generating a second coherent radiation emission having another wavelength, wherein
an optical switching unit (64) is provided which can be switched between a first switching state in which the first radiation emission is coupled into the interferometer module

(16) and a second switching state in which the second radiation emission is coupled into the interferometer module (16),
wherein the optical switching unit (64) is preferably embodied such that switching can be carried out within a maximum of 5 ms, preferably in a range between 50 μs and 5 ms.

12. The system (10) according to claim 11, wherein the system (10) is configured to successively carry out the following in order to measure the distance:
a) to generate a first interference signal by means of the first radiation emission and determine a first distance value;
b) to generate a second interference signal by means of the second radiation emission and to determine a second distance value; and
c) to determine the distance on the basis of the first and second distance values;
wherein a drift velocity is preferably determined when determining the first distance value (a), and the drift velocity is taken into account when determining the distance on the basis of the first and second distance values (c),
wherein the system (10) is preferably configured to determine the first distance value (a) such that a confidence determined for the first distance value falls below a predetermined threshold value.

13. A method for interferometrically measuring a distance between a reference surface (20) and a target surface (22), wherein
a coherent radiation emission with a wavelength dependent on a modulation parameter is generated by means of a tunable radiation source (12); wherein
the modulation parameter is controlled such that the wavelength of the generated radiation emission is modulated periodically between a first and a second reference wavelength;
a first reflection is generated at the reference surface (20) on the basis of a first part of the radiation emission, and a second reflection is generated at the target surface (22) on a basis of a second part of the radiation emission, so that an interference signal is generated by the first reflection and the second reflection;
the interference signal is captured; and
a phase measurement between the first and the second reference wavelength is carried out on the basis of the captured interference signal and the distance between the reference surface (20) and the target surface (22) is determined on the basis of the phase measurement.
